(19) United States
(12) Patent Application Publication
(10) Pub. No.: US 2014/0057156 A1
(43) Pub. Date: Feb. 27, 2014

(54) Polymer-Ionophore Separator

(71) Applicant: Ulrich Hasenkox, Ditzingen (DE)

(72) Inventor: Ulrich Hasenkox, Ditzingen (DE)

(21) Appl. No.: 13/985,791

(22) PCT Filed: Dec. 16, 2011
(86) PCT No.: PCT/EP11/73009

§ 371 Date: Nov. 8, 2013

(30) Foreign Application Priority Data
Feb. 15, 2011 (DE) 102-011004094.3

(51) Int. Cl. H01M 2/16

(52) U.S. Cl. CPC H01M 2/1653
USPC 429/144; 429/248; 429/246

(57) ABSTRACT

An alkali-chalcogen cell, in particular a lithium-sulfur cell. In order to increase the long-term stability and lifespan of the alkali-chalcogen cell, the separator of the alkali-chalcogen cell is provided with a polymer-ionophore component, in particular a polymer-ionophore diaphragm, including a polymeric matrix material and alkali-ionophores, in particular lithium ionophores.

### FIELD OF THE INVENTION

The present invention relates to an alkali-chalcogen cell and a separator for an alkali-chalcogen cell.

### BACKGROUND INFORMATION

Lithium-sulfur batteries (Li-S batteries) are believed to offer the advantage of a substantially greater energy density compared to conventional lithium-ion cells. The lithium-sulfur system provides a theoretical energy density of 2600 Wh/kg (with reference to the active material only), which represents a multiple of the energy density of approximately 580 Wh/kg which is achievable with lithium-ion technologies.

To date, primarily the micro-porous polymer diaphragms or gel diaphragms known from conventional lithium-ion technology are used as separators for lithium-sulfur cells. The conducting salt dissolved in the electrolyte solvent diffuses back and forth between the electrodes through these separators. The diffusion of the solvent and of all compounds dissolved therein between the cathode space and the anode space is also possible.

### SUMMARY OF THE INVENTION

The object of the present invention is an alkali-chalcogen cell, in particular a lithium-sulfur cell, which includes an anode (negative electrode), a cathode (positive electrode), and a separator situated between the anode and cathode. The anode includes an alkali metal, in particular lithium, while the cathode includes a chalcogen, in particular sulfur.

According to the present invention, the separator has a polymer-ionophore component which includes a polymeric matrix material and alkali-ionophores, in particular lithium ionophores. The alkali-ionophores or lithium ionophores are chemically and/or physically, in particular covalently, bound to the matrix material and/or in the matrix material. The alkali-ionophores may be either molecules of one ionophore type or molecules of various ionophore types.

Using a component which is selectively conductive to alkali ions, in particular lithium ions, may advantageously increase the stability and the lifespan of lithium-chalcogen cells. This is based on the fact that, through the use of the polymer-ionophore component, the diffusion of soluble byproducts, for example polysulfides, into the separator or anode space during charging/discharging of the cell may be prevented. This also creates an advantageous reduction in the withdrawal of active materials, for example polysulfides, from the electrochemical reaction, which also leads to an improvement in the capacity and cycle stability of the cell. Polymer-ionophore components may also have an advantageously high ion conductivity. In addition, polymer-ionophore components may also have advantages with regard to flexibility and processability.

Within the scope of one specific embodiment, the polymer-ionophore component is a polymer-ionophore diaphragm or configured in the form of at least one polymer-ionophore diaphragm.

Ion-selective polymer-ionophore components and diaphragms are known from the field of chemical analysis. These include, in particular, a polymer or polymer mixture with introduced ionophores and possibly one or multiple solvents. The ionophores contain groups which may selectively complexify metal ions. The selectivity of the group for a certain metal ion depends on the chemical structure of the ionophores. Some ionophores, as well as their selectivity with respect to alkali ions, are described in the literature by W. Simon, Helvetica Chimica Acta, Vol. 58, pp 1535-1548, 1975). Other ionophores were described in the masters' thesis of Charles V. Cason: “Functionalized Crown Ethers as Ionophores in Ion-Selective Electrodes,” Texas Tech University, December 1986.

The introduction of such ionophores into a polymer creates a polymer-ionophore component which may selectively bind and transport ions, since the ions may move from one binding point to the next. Since the ionophores, due to their size and structure, only selectively bind particular ions and thereby transport them, the polymer-ionophore component is impenetrable to other ions such as polysulfides and also to liquids.

The diameter of a lithium ion Li⁺ is, for example, approximately 1.2 Å, and that of the sulfide ion S²⁻ approximately 3.6 Å. The inner cavity of a crown ether such as 15-crown-5 ether has a diameter of approximately 2 Å and is therefore large enough to let through lithium ions Li⁺, but too small to let through sulfide ions S²⁻.

All polymers which are enduring and non-soluble under the electrochemical conditions in the electrolyte solvent used are suitable as a polymeric matrix material. If necessary, these may be cross-linked polymers. The ionophore is installed into the polymeric matrix material in such a way that it is permanently bound chemically and/or physically, in particular covalently, onto the polymer and may not be dissolved away by the solvents.

All compounds which have a suitable complexation and transport function for alkali ions, in particular lithium ions, are worthy of consideration as ionophores. The structural characteristics contained in the ionophores may be, in particular, those which are known from the crown ethers, for example 12-crown-4, 14-crown-4, 15-crown-5, or 18-crown-6, or which are known from the lariat crown ethers. Due to their side chains, lariat crown ethers may have additional binding points. In addition, by selecting the side chains, the selectivity of lariat crown ethers may be set particularly well.

Ionophore structures based on cis-cyclohexane-1.2-dicarboxamides are also suitable as ionophore structures.

Channel-forming structures, which are known from antibiotics, such as valinomycin, may also serve as ionophores.

Within the scope of another specific embodiment, the alkali-ionophores are selected from the group composed of crown ethers and crown ether derivatives, for example 12-crown-4, 14-crown-4, 15-crown-5 and 18-crown-6, in particular 15-crown-5, lariat crown ethers, cryptands, cis-cyclohexane-3, 4-dicarboxamide, cis-cyclohexane-3, 4-dicarboxamide derivatives, macrolides, in particular valinomycin or valinomycin derivatives, or combinations thereof.

Within the scope of another specific embodiment, the alkali-ionophores contain or are 15-crown-5 crown ether or 15-crown-5 crown ether derivatives.

Within the scope of another specific embodiment, the alkali-ionophores are selective for ions of a certain alkali metal, in particular for lithium ions. Different ions, such as polysulfides, may thus advantageously not pass.

Within the scope of another specific embodiment, the polymer-ionophore component, in particular the polymer-ionophore diaphragm, also contains at least one ionophore solvent. The ion selectivity of the polymer-ionophore component or the polymer-ionophore diaphragm may be advantageously further improved through selection of the ionophore solvent. A different solvent or solvent mixture may be used for the ionophore solvent than for the electrolyte solvent or solvents.

Within the scope of another specific embodiment, the polymer-ionophore component, in particular the polymer-ionophore diaphragm, is impenetrable for electrolyte solvents.

Within the scope of another specific embodiment, the alkali-ionophores are lithium ionophores.

The separator may basically be made up completely by the polymer-ionophore component, for example in the form of a polymer-ionophore diaphragm.

However, it is also possible to use a different diaphragm, for example an inert, porous one, which is coated on one or both sides with the polymer-ionophore component.

Within the scope of another specific embodiment, the separator therefore has at least one additional diaphragm, for example a porous, in particular a microporous, polymer diaphragm, for example based on polyolefin, or a gel diaphragm, for example based on a polymer welled in an electrolyte solvent. Since the separation effect may be ensured by even a very thin polymer-ionophore diaphragm, the rest of the separator may advantageously be formed of a stable, inexpensive material. In addition, a thin barrier has positive effects on the diffusion speed of the alkali ions, in particular lithium ions.

Within the scope of another specific embodiment, at least one side of the additional diaphragm borders on the/a polymer-ionophore component, in particular the polymer-ionophore diaphragm. In particular, at least one side of the additional diaphragm may be coated with the/a polymer-ionophore component, in particular the polymer-ionophore diaphragm. For example, the additional diaphragm may border on the polymer-ionophore component, in particular the polymer-ionophore diaphragm, on the cathode or the anode side, or be coated with the polymer-ionophore component, in particular the polymer-ionophore diaphragm. If necessary, however, the additional diaphragm may border on a polymer-ionophore component, in particular a polymer-ionophore diaphragm, on both sides, i.e., on both the cathode side and the anode side or be coated with a polymer-ionophore diaphragm on both sides.

Through the use of a polymer-ionophore component according to the present invention which only transports alkali ions, in particular lithium ions, the cathode space and the anode space may be advantageously strictly separated. This also offers the option of operating the cell with two different electrolytes, namely one in the cathode space and the other in the anode space. The use of two electrolytes which are permanently separated offers the advantage of using solvents which are optimized for use in the respective electrode space and do not represent a compromise of the properties. In the same way, it would also be possible to use solvents in the cathode space which are not compatible with the anode and vice versa.

Within the scope of another specific embodiment, the cell includes an anode-side electrolyte solvent and a cathode-side electrolyte solvent which is different from the anode-side solvent.

With regard to additional advantages and features of the alkali-chalcogen cell according to the present invention, explicit reference is made to the explanations in conjunction with the separator according to the present invention, the usage according to the present invention, and the drawing description.

A further object of the present invention is a separator for an alkali-chalcogen cell, in particular a lithium-sulfur cell, which has a polymer-ionophore component, in particular a polymer-ionophore diaphragm, which includes a polymeric matrix material and alkali-ionophores, in particular lithium ionophores. Here the alkali-ionophores or lithium ionophores are, in particular, chemically and/or physically, in particularly, covalently, bound to the matrix material and/or in the matrix material.

With regard to additional advantages and features of the separator according to the present invention, explicit reference is made to the explanations in conjunction with the alkali-chalcogen cell according to the present invention, the usage according to the present invention, and the drawing description.

Moreover, the present invention relates to the usage of a polymer-ionophore component, in particular a polymer-ionophore diaphragm which includes a polymeric matrix material and alkali-ionophores, in particular lithium-ionophores, as a separator for an alkali-chalcogen cell, in particular a lithium-sulfur cell. Here the alkali-ionophores or lithium ionophores are, in particular, chemically and/or physically, in particular covalently, bound to the matrix material and/or in the matrix material.

With regard to additional advantages and features of the usage according to the present invention, explicit reference is made to the explanations in conjunction with the alkali-chalcogen cell according to the present invention, the separator according to the present invention, and the drawing description.

Additional advantages and advantageous embodiments of the objects according to the present invention are illustrated by the drawings and explained in the following description. It must be noted that the drawings have solely descriptive character and are not intended to restrict the present invention in any form.

### BRIEF DESCRIPTION OF THE DRAWINGS

FIG. 1 shows a schematic cross section of a first specific embodiment of a separator according to the present invention having a polymer-ionophore diaphragm.

FIG. 2 shows a schematic cross-section of a second specific embodiment of a separator according to the present invention having a polymer-ionophore diaphragm.

FIG. 3 shows a schematic cross-section of a third specific embodiment of a separator according to the present invention having two polymer-ionophore diaphragms and an additional diaphragm.

FIG. 4 shows the chemical structural formula of 15-crown-5 crown ether.

### DETAILED DESCRIPTION

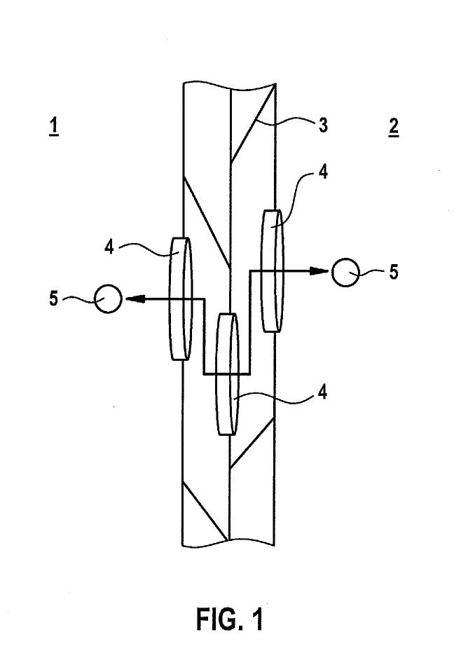

FIG. 1 shows a first specific embodiment of a separator according to the present invention. FIG. 1 shows that the separator may be situated between anode 1 and cathode 2. FIG. 1 illustrates that the separator has a polymer-ionophore diaphragm 3, 4 which includes a polymeric matrix material 5 and alkali-ionophores 4. Alkali ionophores 4 may, in particular, be lithium ionophores. FIG. 1 shows that alkali-ionophores 4 are bound chemically and/or physically, in particular covalently, to or in the matrix material 5.

FIG. 1 shows that the alkali-ionophores 4 are selective for ions of a certain alkali metal 5, in particular lithium ions. The polymer-ionophore diaphragm 3, 4 may be impenetrable to electrolyte solvents. This allows the use of a different electrolyte solvent on the anode side 1 than on the cathode side 2. This allows an advantageous optimization of the electrolyte solvents especially for the anode side or the cathode side.

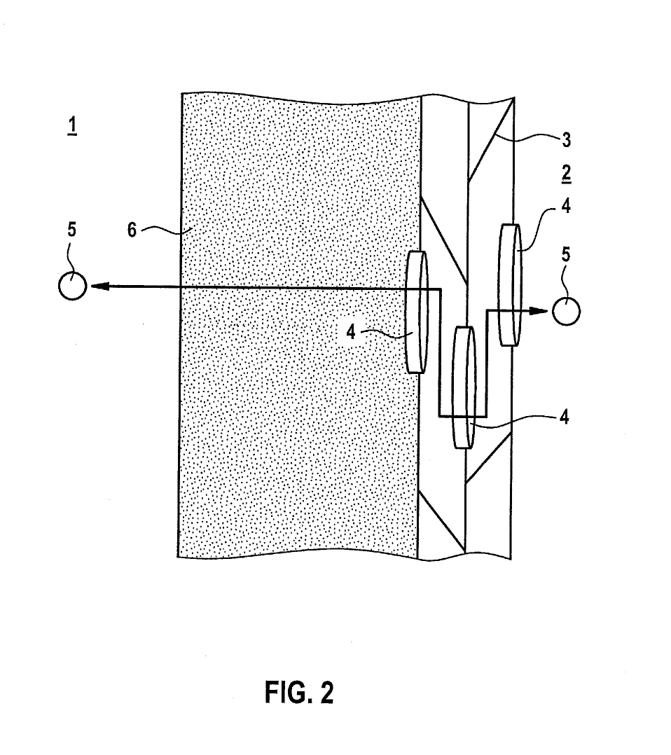

The second specific embodiment, which is shown in FIG. 2, essentially differs from the specific embodiment shown in FIG. 1 in that the separator includes an additional diaphragm 6, for example a porous diaphragm or a gel diaphragm. FIG. 2 shows that this additional diaphragm 6 may be coated with a polymer-ionophore diaphragm 3, 4 on one side, for example on the cathode side, as shown in FIG. 2, or on the anode side, which is not shown in FIG. 2.

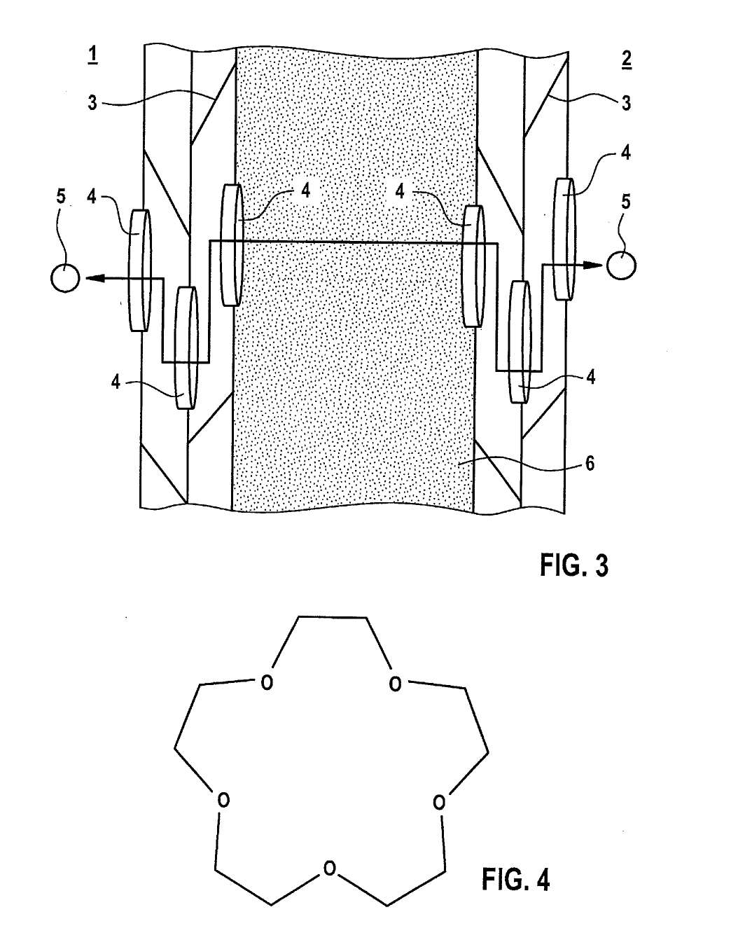

The third specific embodiment, which is shown in FIG. 3, essentially differs from the second specific embodiment shown in FIG. 2 in that the additional diaphragm 6 is coated with a polymer-ionophore diaphragm 3, 4 both on the cathode side and the anode side.

Within the scope of the present invention, alkali-ionophores 4 may, for example, be selected from the group composed of crown ethers and crown ether derivatives, lariat crown ethers, cryptands, cis-cyclohexane-3, 4-dicarboxamide, cis-cyclohexane-3, 4-dicarboximide derivatives, macrolides (in particular valinomycin or valinomycin derivatives), or combinations thereof.

FIG. 4 shows the chemical structure of a representative of this group, namely 15-crown-5 crown ether, which is particularly suitable as an ionophore for lithium ions.

1-13. (canceled)

14. An alkali-chalcogen cell, in particular a lithium-sulfur cell, including:
an anode;
a cathode; and
a separator situated between the anode and the cathode, the anode including an alkali metal and the cathode including a chalcogen, the separator having a polymer-ionophore component which includes a polymeric matrix material and alkali-ionophores, the alkali-ionophores being at least one of chemically, physically, and covalently, bound to or in the matrix material.

15. The alkali-chalcogen cell of claim 14, wherein the separator has a polymer-ionophore diaphragm.

16. The alkali-chalcogen cell of claim 14, wherein the alkali-ionophores are selective for ions of a certain alkali metal.

17. The alkali-chalcogen cell of claim 15, wherein in the polymer-ionophore component, the polymer-ionophore diaphragm contains at least ionophore solvents.

18. The alkali-chalcogen cell of claim 15, wherein in the polymer-ionophore component, the polymer-ionophore diaphragm is impenetrable to electrolyte solvents.

19. The alkali-chalcogen cell of claim 14, wherein the alkali-ionophores include lithium ionophores.

20. The alkali-chalcogen cell of claim 14, wherein the alkali-ionophores are from crown ethers or crown ether derivatives, including 12-crown-4, 14-crown-4, 15-crown-5, and 18-crown-6, in particular 15-crown-5, lariat crown ethers, cryptands, cis-cyclohexane-3, 4-dicarboxamide, cis-cyclohexane-3, 4-dicarboxamide derivatives, macrolides, valinomycin or valinomycin derivatives, or combinations thereof.

21. The alkali-chalcogen cell of claim 20, wherein the alkali-ionophores are 15-crown-5 crown ethers or 15-crown-5 crown ether derivatives.

22. The alkali-chalcogen cell of claim 14, wherein the separator includes at least one additional diaphragm, which is a porous diaphragm or a gel diaphragm.

23. The alkali-chalcogen cell of claim 22, wherein at least one side of the additional diaphragm borders on the polymer-ionophore diaphragm of the the polymer-ionophore component.

24. The alkali-chalcogen cell of claim 14, wherein the cell includes an anode-side electrolyte solvent and a cathode-side electrolyte solvent which is different from the anode-side electrolyte solvent.

25. A separator for an alkali-chalcogen cell, comprising:
a polymer-ionophore component having a polymer-ionophore diaphragm, which includes a polymeric matrix material and alkali-ionophores;
wherein the alkali-ionophores are at least one of chemically, physically, and covalently bound to or in the matrix material.

26. The separator of claim 25, wherein the alkali-chalcogen cell includes a lithium-sulfur cell, and wherein the alkali-ionophores include lithium ionophores.

27. A polymer-ionophore component, comprising:
a polymeric matrix material and alkali-ionophores;
wherein the alkali-ionophores are at least one of chemically, physically, and covalently bound to or in the matrix material as a separator for an alkali-chalcogen cell.

28. The polymer-ionophore component of claim 27, wherein the polymer-ionophore component includes a polymer-ionophore diaphragm, wherein the alkali-ionophores include lithium ionophores, and wherein the alkali-chalcogen cell includes a lithium-sulfur cell.
